(19) United States
(12) Patent Application Publication
(10) Pub. No.: US 2018/0343431 A1
(43) Pub. Date: Nov. 29, 2018

(54) METHOD AND APPARATUS FOR DISPARITY-BASED IMAGE ADJUSTMENT OF A SEAM IN AN IMAGE DERIVED FROM MULTIPLE CAMERAS

(71) Applicant: NOKIA TECHNOLOGIES OY, Espoo (FI)

(72) Inventors: Muninder Veldandi, Sunnyvale, CA (US); Prasad Balasubramanian, Sunnyvale, CA (US); Basavaraja S. Vandrotti, Sunnyvale, CA (US); Kim Gronholm, Helsinki (FI)

(21) Appl. No.: 15/603,957

(22) Filed: May 24, 2017

(51) Int. Cl. H04N 13/00; G06T 7/11; H04N 13/02

(52) U.S. Cl. CPC H04N 13/0022; G06T 7/11; H04N 13/0271; H04N 5/23238; G06T 2207/20021; G06T 2207/10028; H04N 13/0203

(57) ABSTRACT

A method, apparatus and computer program product are provided to combine images captured by multiple cameras into a composite panoramic image, such as a 360° panorama, in a manner that reduces image defects and other artifacts at or near a seam between images. In some implementations of example embodiments, the overlapping portions of two images are divided into a plurality of seam regions. Upon selection of a seam region, the seam region is further divided into seam segments. In each seam segment, a depth level associated with the segment is used to calculate convergence value that is applied such that different scaling factors may be applied to image elements at different depths within a given image. Based on the applied convergence values and the resulting stitching at the seam region the image quality at the seam area can be efficiently improved.

### TECHNICAL FIELD

An example embodiment relates generally to systems that provide for image processing. Example implementations are particularly directed to systems, methods, and apparatuses for combining images captured by multiple cameras, such as images used to form a 360° panorama or other panoramic image, for example, in a manner that improves the appearance of image portions at or near a seam between two images captured by separate cameras.

### BACKGROUND

As viewers of visual media and other content have continued to seek improved media experiences, content creators have increasingly turned to the use of panoramic views, such as wide-angle views and 360° images and videos, to create immersive viewing experiences that can be viewed through the use of virtual reality systems, systems that use a head-mounted display, and other systems configured to present content across a wider field of view than that offered by conventional image viewing systems.

To create such panoramic views, many content creators have turned to camera arrays and multi-camera systems that capture partially overlapping images that can be combined to form a composite image that presents a wider field of view than that available from typical single-camera systems. However, the combination of multiple images raises a number of technical challenges, particularly in situations where differences between cameras and camera orientations, along with other technical challenges, result in incongruities and other image artifacts at or near the seam between two images. The inventors of the invention disclosed herein has identified these and other technical challenges, and have developed the solutions described and otherwise referenced herein.

### BRIEF SUMMARY

A method, apparatus and computer program product are therefore provided in accordance with an example embodiment in order to provide for the combining of images captured by multiple cameras into a composite image in a manner that reduces image defects and other artifacts at or near a seam between images. In this regard, the method, apparatus and computer program product of an example embodiment involve the use of a determined depth value for the overlapping portions of two images to determine a location at which to establish a seam and to apply one or more scaling factors in the seam area. In some example implementations, the seam area is divided into multiple segments and the convergence value is applied to each segment based on the representative depth value of the segment.

In an example embodiment, a method is provided that includes receiving a set of image data associated with region of a first image and a set of image data associated with a region of a second image, wherein the region of the first image and the region of the second image comprise an overlapping portion of the first image and the second image; selecting a seam region with in the overlapping portion of the first image and the second image; dividing the seam region into a plurality of image segments; determining, for each image segment, a depth value; determining, for each image segment, a convergence value, wherein the convergence value is based at least in part on the depth value of the image segment; and applying each convergence value to the image segment. In some example implementations of such a method, the first image and the second image are components of a three-dimensional video image.

In some example implementations, a seam width associated with seam region is variable along the length of the seam region. In some such example implementations, and in other example implementations, the convergence value is further based on a disparity map associated with the overlapping portion of the first image and the second image.

In some such example implementations, and in other example implementations, selecting a seam location within the overlapping portion of the first image and the second image comprises automatically calculating an error metric associated with a seam region. In some such example implementations, and in other example implementations, the error metric is an image distortion error metric.

In some such example implementations, and in other example implementations, the method further comprises receiving an indication of a request by a user to relocate the seam location; and relocating the seam location.

In another example embodiment, an apparatus is provided that includes at least one processor and at least one memory that includes computer program code with the at least one memory and the computer program code configured to, with the at least one processor, cause the apparatus to at least receive a set of image data associated with region of a first image and a set of image data associated with a region of a second image, wherein the region of the first image and the region of the second image comprise an overlapping portion of the first image and the second image; select a seam region with in the overlapping portion of the first image and the second image; divide the seam region into a plurality of image segments; determine, for each image segment, a depth value; determine, for each image segment, a convergence value, wherein the convergence value is based at least in part on the depth value of the image segment; and apply each convergence value to the image segment. In some example implementations of such an apparatus, the first image and the second image are components of a three-dimensional video image.

In some such example implementations, and in other example implementations, a seam width associated with seam region is variable along the length of the seam region. In some such example implementations, and in other example implementations, the convergence value is further based on a disparity map associated with the overlapping portion of the first image and the second image. In some such example implementations, and in other example implementations, selecting a seam location within the overlapping portion of the first image and the second image comprises automatically calculating an error metric associated with a seam region. In some such example implementations, and in other example implementations, the error metric is an image distortion error metric.

In some such example implementations, and in other example implementations, the at least one memory and the computer program code further configured to, with the processor, cause the apparatus to at least receive an indication of a request by a user to relocate the seam location; and relocate the seam location.

In a further example embodiment, a computer program product is provided that includes at least one non-transitory computer-readable storage medium having computer-executable program code instructions stored therein with the computer-executable program code instructions including program code instructions configured to receive a set of image data associated with region of a first image and a set of image data associated with a region of a second image, wherein the region of the first image and the region of the second image comprise an overlapping portion of the first image and the second image; select a seam region with in the overlapping portion of the first image and the second image; divide the seam region into a plurality of image segments; determine, for each image segment, a depth value; determine, for each image segment, a convergence value, wherein the convergence value is based at least in part on the depth value of the image segment; and apply each convergence value to the image segment. In some example implementations of such a computer program product, the first image and the second image are components of a three-dimensional video image.

In some such example implementations, and in other example implementations, a seam width associated with seam region is variable along the length of the seam region. In some such example implementations, and in other example implementations, the convergence value is further based on a disparity map associated with the overlapping portion of the first image and the second image. In some such example implementations, and in other example implementations, wherein selecting a seam location within the overlapping portion of the first image and the second image comprises automatically calculating an error metric associated with a seam region.

In some such example implementations, and in other example implementations, the computer-executable program code instructions further comprise program code instructions configured to: receive an indication of a request by a user to relocate the seam location; and relocate the seam location.

### BRIEF DESCRIPTION OF THE DRAWINGS

Having thus described certain example embodiments of the present disclosure in general terms, reference will hereinafter be made to the accompanying drawings, which are not necessarily drawn to scale, and wherein:

FIG. 1 depicts the respective fields of view of first and second cameras configured to capture images that are processed in accordance with an example embodiment of the present invention;

FIG. 2 is a block diagram of an apparatus that may be specifically configured in accordance with an example embodiment of the present invention;

FIG. 3 is a block diagram illustrating example adjacent images and the overlapping portion between such adjacent images;

FIG. 4 depicts a graphical representation of an example segmentation of a seam area that may be used to illustrate aspects of an example embodiment of the present invention;

FIG. 5A depicts an example image to which aspects of an example embodiment of the present invention may be applied;

FIG. 5B depicts an example resulting image to which aspects of an example embodiments of the present invention have been applied; and

FIG. 6 is a flowchart illustrating the operations performed, such as by the apparatus of FIG. 2, in accordance with an example embodiment of the present invention.

### DETAILED DESCRIPTION

Some embodiments will now be described more fully hereinafter with reference to the accompanying drawings, in which some, but not all, embodiments of the invention are shown. Indeed, various embodiments of the invention may be embodied in many different forms and should not be construed as limited to the embodiments set forth herein; rather, these embodiments are provided so that this disclosure will satisfy applicable legal requirements. Like reference numerals refer to like elements throughout. As used herein, the terms “data,” “content,” “information,” and similar terms may be used interchangeably to refer to data capable of being transmitted, received and/or stored in accordance with embodiments of the present invention. Thus, use of any such terms should not be taken to limit the spirit and scope of embodiments of the present invention.

Additionally, as used herein, the term ‘circuitry’ refers to (a) hardware-only circuit implementations (e.g., implementations in analog circuitry and/or digital circuitry); (b) combinations of circuits and computer program product(s) comprising software and/or firmware instructions stored on one or more computer readable memories that work together to cause an apparatus to perform one or more functions described herein; and (c) circuits, such as, for example, a microprocessor(s) or a portion of a microprocessor(s), that require software or firmware for operation even if the software or firmware is not physically present. This definition of ‘circuitry’ applies to all uses of this term herein, including in any claims. As a further example, as used herein, the term ‘circuitry’ also includes an implementation comprising one or more processors and/or portion(s) thereof and accompanying software and/or firmware. As another example, the term ‘circuitry’ as used herein also includes, for example, a baseband integrated circuit or applications processor integrated circuit for a mobile phone or a similar integrated circuit in a server, a cellular network device, other network device, and/or other computing device.

As defined herein, a “computer-readable storage medium,” which refers to a non-transitory physical storage medium (e.g., volatile or non-volatile memory device), can be differentiated from a “computer-readable transmission medium,” which refers to an electromagnetic signal.

A method, apparatus and computer program product are provided in accordance with an example embodiment in order to provide for the combining of images captured by multiple cameras into a composite image in a manner that reduces image defects and other artifacts at or near a seam between images. In this regard, a composite image (such as a panoramic image formed through the combination of multiple images, for example) may be generated, at least in part, by the use of a determined depth value for multiple segments of the overlapping portions of two images. Based at least in part on the determined depth values, a location within the overlapping portion of two images may be selected as the seam location and a scaling factor (which may be refered to herein as convergence and/or a convergence factor) may be applied on a segment-specific basis to blend the overlapping images in the seam area.

The use of composite images formed through the combination of images captured by multiple cameras has become increasingly popular, particularly amongst content creators who seek to create an immersive viewing experience and amongst viewers who seek such immersive viewing experiences. In some contexts, composite images take the form of panoramic images that are used to present a very wide field of view, such as a 360° view or other wide field of view, for example, to a viewer who is using a specialized viewing device, such as a virtual reality headset, another head-mounted display, or another viewing arrangement that is capable of presenting a wide field of view to a viewer.

Example embodiments of the invention described and otherwise disclosed herein are generally directed to the field of image processing. Some example implementations are particularly directed to approaches to stitching and streaming images, including but not limited to 360° and other panoramic images, which may be used in connection with 3D-360, Virtual Reality, Augmented Reality, and/or other similar applications that use overlapping image content captured from multiple cameras. Some example embodiments are directed to generating high quality stitching from multiple images when disparities between the corresponding image portions in an overlap region of a composite image are present and can be determined.

In some contexts and situations, the process of stitching 2D and 3D 360° videos, for example, at reasonably high quality can be a computationally intensive and time-consuming process. To address these, and other technical challenges, some example implementations of embodiments of the invention provide for an optimized process for stitching 2D and 3D 360° videos and/or other images from multi-camera arrays that involve at least some overlap between images. In some situations, such implementations would tend to be beneficial in live streaming use cases and offline content workflows that are subject to limited timing requirements and/or limited processing resources.

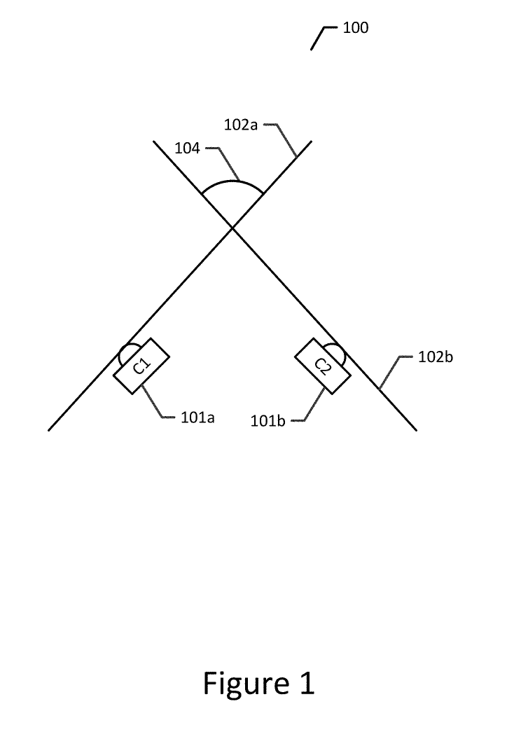

As noted herein, some example embodiments of the invention described and/or otherwise disclosed herein involve multi-camera arrays. As such, some example implementations contemplate the use of devices suitable for capturing images used in virtual reality and other immersive content environments, such as Nokia's OZO system, where multiple cameras are placed in an array such that each camera is aimed in a particular direction to capture a particular field of view. Regardless of the particular camera arrangement used in example implementations of the example embodiments described herein, the panoramic view that is generated in accordance with an example embodiment of the present invention is usually based upon images captured by at least two cameras. In the example camera array 100 depicted in FIG. 1, two cameras 101a (which is labeled C1 for the purposes of clarity) and 101b (which is labeled as C2 for the purposes of clarity) are present. While only two cameras are depicted in camera array 100 in FIG. 1, it will be appreciated that, in other example camera arrays, images may be captured by more than two cameras, such as three or more cameras, and then combined to generate a panoramic image. For example, cameras C1 and C2 may be included as a part of a plurality of cameras C1, C2, C3, C4, . . . , Cₙ. Moreover, the plurality of cameras may be arranged such that images captured by C1 and C2 have mutually overlapping portions, images captured by C2 and C3 have mutually overlapping portions, images captured by C3 and C4 have mutually overlapping portions, and images captured by Cₙ and C1 have mutually overlapping portions, such that when the images are combined, a 360° view is created. A variety of different types of cameras having different fields of view may be used in order to capture the images that can be combined to generate one or more panoramic views. In the example array described herein with respect to FIG. 1, however, each of the cameras 101a and 101b is a fisheye camera having a 180° field of view. Moreover, while each of the cameras 101a and 101b may be the same type of camera and may have a field of view that extends over the same angular range, such as 180° for example, the cameras used in example implementations of array 100 and/or other arrays may differ from one another and may have different fields of view in other embodiments. For example, one or more of the cameras in an example array may have a field of view greater than 180°, such as a 195° field of view, or a field of view less than 180°.

As shown in FIG. 1, the cameras 101a and 101b are positioned so as to have different fields of view. However, the fields of view of the at least two cameras 101a and 101b have a mutually overlapping portion. As shown in FIG. 1, for example, the first camera 101a (or C1) has a 180° field of view as represented by line 102a. Similarly, the second camera 101b (or C2) has a 180° field of view as represented by line 102b. As shown in the example arrangement in FIG. 1, the fields of view of each of the cameras 101a and 101b differ from one another, but share a mutually overlapping portion. In this regard, the fields of view of the first and second cameras overlap in the region designated 104 in FIG. 1. While the example array 100 depicted in FIG. 1 shows the cameras 101a and 101b as being arranged in a symmetrical relationship such that the first camera 101a and the second camera 101b are disposed at the same angle and spaced by the same distance from the overlapping portion of their respective field of view, the cameras may be differently positioned and oriented in other embodiments.

To form a panoramic image, it is often necessary to stitch the images received from each camera together, such that a viewer can be presented with a continuous, combined image that presents image elements captured by multiple cameras. To allow for the creation of such combined panoramic images, the adjacent cameras within a camera array are often configured and oriented such that portions of their respective fields of view overlap. While the overlapping fields of view ensure that images from adjacent cameras typically allow for the creation of a continuous panoramic image that reflects the entire combined field of view of multiple cameras, such arrangements also pose a number of technical challenges when attempting to establish a seam between two adjacent images in a manner that limits the artifacts and/or other defects that can become visible in image portions at and/or near a seam.

Some such technical challenges are inherent to the orientation and/or calibration of cameras within a multiple-camera array. In many typical situations and contexts, camera calibration is typically performed in a manner that favors infinite scene location. Consequently, objects located relatively near the camera(s) may be subject to parallax effects and/or other divergences or defects. In some such situations, and in other situations where two or more cameras have overlapping fields of view, objects and/or other image elements at or near a seam area (such as those that appear in portions of multiple images, for example) may appear as ghosted and/or blurred image artifacts, depending on the approach used to combine the adjacent images. Regardless of the source of image artifacts and/or other defects at the seam area, such artifacts and defects can cause disruptions to the viewing experience, cause the combined panoramic image to depart from the intent of the content creator or director, and/or may be otherwise undesired.

In order to implement high quality stitching of overlapping images (and thus create an improved viewing experience), depth variations in the overlapping regions should be handled carefully to avoid the exacerbation of the existing technical challenges and/or image defects. However, some of the approaches that may be used to attempt to address the technical challenges associated with reducing the defects and other image artifacts associated with the combining of two adjacent images raise additional technical challenges and/or introduce additional image defects. For example, some geometric-based stitching techniques, (such as those that incorporate affine and/or homography approaches, for example) generate additional stitching artifacts, particularly in situations where the depicted scene includes depth variations in overlap region. Similarly, some of the faster blending approaches (such as multiband blending, for example) are susceptible to introducing or exacerbating image artifacts in the seam region, particularly in situations where the seam region contains content with varying depth. It will be appreciated that the presence of such artifacts may become unacceptably high in situations involving stereo images, as the objects in a given scene may become shifted in a manner that causes the artifacts to become highly apparent.

Some other approaches are computationally intensive and may require excessive computing resources to implement. For example, some approaches involve computing optical flow and/or disparity vectors and performing a view synthesis of the overlap region from disparity and native camera images. While some such approaches may provide for improved results the computational intensiveness of such approaches often render them inappropriate in applications with limited computing resources and/or timing constraints, such as live broadcasting of virtual reality content, for example.

In contrast, some implementations of example embodiments of the invention described and/or otherwise disclosed herein provide for improved image combination results in a relatively computationally efficient manner by using optical flows and/or depth maps and adjusting the relevant convergence and/or other scaling factor to better align the seam regions. Moreover, some example implementations provide for improved stitching output by using optical flow-based stitching after the two or more images in a composite image are modified using a convergence map. As such, some example implementations of embodiments of the invention described and/or otherwise disclosed herein involve the use of a determined disparity between images at key frame intervals and the modification of the image(s) at the seam region to improve matching between overlapping content.

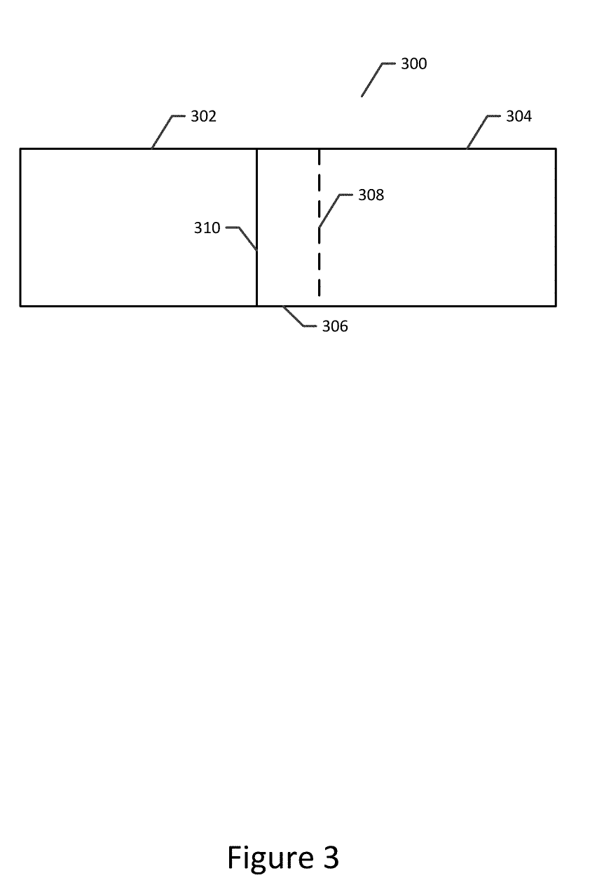

As noted herein, example embodiments of the invention described and/or otherwise disclosed herein involve the formation of a composite image from multiple adjacent images that have at least one overlapping portion. FIG. 3 depicts an example image pair 300 that reflects a potential arrangement of adjacent images that may be stitched together to form a panoramic image and which may be subject to at least some of the technical challenges described herein and used in connection with some of the solutions described herein. As shown in FIG. 3, example image pair 300 includes a first image 302 and a second image 304. In some example implementations of image pair 300, the first image 302 may be captured by one camera in an array, such as camera 101a shown in FIG. 1, for example, and the second image may be captured by a second camera in the same array, such as camera 101b shown in FIG. 1, for example. The images 302 and 304 are shown in FIG. 3 as having an overlapping portion 306, wherein image elements appear in both the first image 302 and the second image 304. For example, and as shown in FIG. 3, the right edge 308 of image 302 contains image elements that are to the right, for example, of image elements at or near the left edge 310 of image 304, such that the overlapping region 306 is defined in the example presented in FIG. 3 as the area between edges 310 and 308. As shown in FIG. 3, image 304 is shown as being partially overlaid over image 302, such that edge 308 is shown as a dashed line for the purposes of clarity. However, it will be appreciated that FIG. 3 is not necessarily drawn to scale, and that, in some instances, image 302 may be overlaid over image 304. In some example implementations of image pair 300, the overlapping portion 306 may be a product of the camera associated with image 302 having a field of view that intersects and/or otherwise overlaps with the field of the view of the camera associated with the second image 304. For example, and with reference to FIG. 1, the overlapping image portion 306 in FIG. 3 may correspond to at least a portion of the region 104 established by intersecting fields of view 102a and 102b shown in FIG. 1.

While the overlapping region 306 of example image pair 300 may generally correspond to portions of images 302 and 304 that depict the same image elements, many of the technical challenges addressed herein arise in situations where the appearance of a particular image element differs from image to image. For example, parallax effects, difference in viewing angle between cameras, differences in the distance from each camera to the image element, differences in focal lengths between the two cameras, and/or differences in the image capturing elements of each camera may result in an image element that appears in one image having a different orientation, size, coloring and/or shading, focus, and/or other aspect of its appearance in an adjacent image. Many of these differences may be exacerbated if there are image elements at multiple depths within the overlapping region 306. In some example implementations, an OZO camera and/or another camera array is used to capture multiple image. In such example situations, most of the image content may be copied to an output panorama, while overlapping regions of images are separately processed to create a seam area that can be copied to the output panorama.

In many contexts, the overlapping portion of a pair of images used in the creation of a panoramic image and/or other composite image will contain multiple image elements at multiple depths of field. The application of many conventional approaches to establishing a seam and combining images (coupled with the underlying parallax and other optical effects) often results in an image where elements far away from the cameras match relatively closely, while image elements that are closer to the camera often mismatched, blurred, or otherwise subject to image defects. In order to more closely match objects that are closer to the camera, and to generally improve the appearance of composite images, example embodiments of the invention involve applying one or more scaling factors (each of which may be referred to herein a “convergence” or “convergence factors”). When applying a single convergence, the objects present in a single depth level (that is, the level that corresponds to a particular, limited range of depth) will become aligned in the overlap region. As such, example implementations of the invention described and/or otherwise disclosed herein involve the use of a determine depth of the scene in a given image segment to define the relevant convergence value and to allow for the application of one or more different scaling factors for each different depth level. By separately determining and converging elements at differing depth levels within the overlapping regions of a composite image, objects that appear in the overlapping region can be matched in a manner that improves their appearance and results in higher quality stitching.

Some example implementations of embodiments of the invention disclosed and/or otherwise described herein involve a two-step approach: (1) computing the convergence of a given seam region, and (2) determining an optimal seam region in the overlap are.

Some approaches to computing the convergence of a given seam region involve using a disparity map for the overlap regions such that the convergence of a given seam region is modified to reducing artifacts in the particular seam region of the overlapping images. In some example implementations taking such an approach, the seam region is divided into multiple segments. For example, in the case of a vertical seam, the seam region may be divided vertically into N equal interval segments. Likewise, in the case of a horizontal seam, the seam region may be divided into N equal interval segments. It will be appreciated that while some of the examples provided herein depict equal interval segments disposed along a vertical seam, other arrangments may be used in other example implementations of the invention described and/or otherwise disclosed herein, including but not limited to seam regions that are divided into unequally sized segment and/or involve curved seams and/or other seam shapes. Regardless of the arrangement of the seam segments, a convergence value is computed for every relevant segment, based at least in part on the average depth of that segment. It will be appreciated that this approach will tend to improve the stitching results, particularly to the extent that it reduces the effect of background material being scaled when foreground material scaled by a convergence factor to allow it to align properly.

Some example implementations involve generating a convergence map from one or more optical flow. In such example implementations, the disparity between two images in a given seam region segment is computed between the cameras for the overlapping content. It will be appreciated that in some situations, the disparity map could be a dense map, while in other situations, the disparity map may be a sparse map, depending on the features in the given segment used in connection with computing the relevant disparities. Once the disparity map is generated, a convergence map is generated using the disparity map. This convergence map can be used, for example to modify every pixel in the overlap region by the amount specified at that location in the convergence map. In some example implementations, the convergence map will provide for modification through scaling based on the convergence value. The relationship between convergence and disparity can be expressed as C (x,y)=k*d(x,y), where k is a constant.

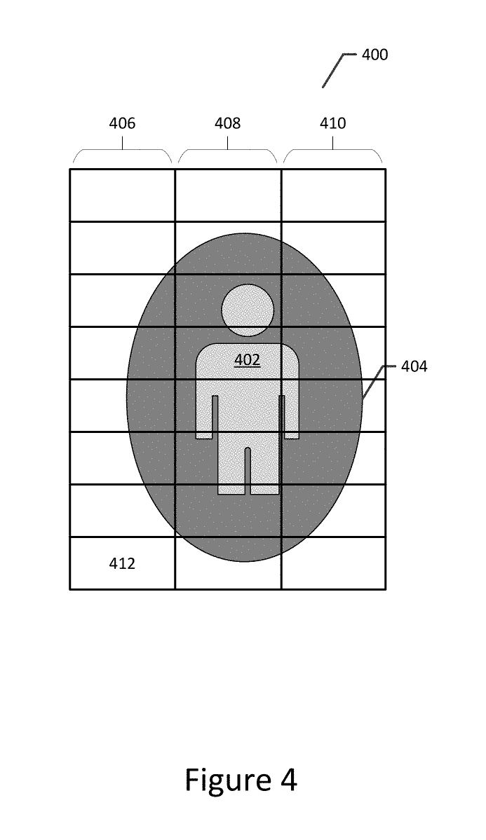

FIG. 4 presents an image portion 400 which illustrates some of these aspects of embodiments of the invention. In FIG. 4, image portion 400 is a depiction of an overlap area of two adjacent images. As shown, image portion 400 contains a first element 402 which is at a first depth within the image portion 400 and a second element 404 which is at a second, different depth within the image portion 400. Image portion 400 is also divided into three seam regions 406, 408, and 410. It will be appreciated that while FIG. 4 depicts only three seam regions, this limitation on the number of seam regions shown is done for the purposes of clarity, and should not be construed as a limit on the number of seam regions that may be applied to an image portion. Rather, it should be appreciated that any number of seam regions may be associated with an overlapping image portion, and the number of seam regions established may vary based on a number of factors, including but not limited to the image portion size, arrangement, the associated available computing resources, aspects of the image, and/or other factors. Likewise, while the seam regions shown are vertical in FIG. 4, other seam region orientations may be used in connection with example implementations of the invention described and/or disclosed herein.

As shown in FIG. 4, each of the seam regions is divided into multiple seam segments, such as seam segment 412. As with the number of seam regions, it will be appreciated that, while FIG. 4 depicts eight seam segments of equal size in each seam regions, other example implementations may be performed use more or fewer seam segments and/or seam segments that vary in size from segment to segment. In keeping with some example implementations of embodiments of the invention, a convergence value may be automatically computed on per-segment basis. For example, a convergence value may be calculated for segment 412 and for each other segment in a given seam region (or throughout the entire image portion). As discussed herein, the convergence value is based at least in part on the average disparity value in the relevant segment.

Some approaches to computing an optimal seam region in the overlap area involve an automatic computation of the seam region, which may be optionally adjusted and/or fine-tuned manually. In some situations, depending on the arrangement of the relevant cameras and their resulting images, the optimal seam region could be horizontal, vertical and/or conform to a different shape. Moreover, the optimal seam region may have a variable width across the seam region. In the allowed overlap area (ranging up to 60°, for example), the seam region can be computed automatically as a first step. If needed, this can be optionally adjusted manually for finetuning as a next step. In some situations, including but not limited to situations where an overlap area includes a relatively wide span (such as the 60° span that can occur in some camera configurations, for example) it may be advantageous and computationally more efficient to first select the seam region to be use prior to applying the techniques described herein, including but not limited to dividing the seam region into multiple segments and computing and applying a convergence value and/or other scaling factor to the particular segments.

In connection with automatically computing the seam region, some example implementations involve computing the convergence from the relevant optical flow using a linear mapping at every probable seam area. A distortion error may then computed between cameras. In some example implementations, the location which gives the minimum distortion error is determined to be (and selected as) the final seam location. It will be appreciated that some example implementations contemplate that the width of the seam area is variable and may be computed by guidance from an optical flow and/or depth map. The optimal and/or other chosen seam area may be determined by identifying the minimum distortion criterion after applying the convergence map (which, in accordance with some example implementations, is derived from the depth of a given segment or set of segments).

In some example implementations that provide for the manual selection and/or adjustment of a seam location, a user can drag (such as in a user interface, for example) and/or otherwise cause the movement of the seam region in the overlap area. In some such example implementations, for every probable position, the relevant convergence is computed from the optical flow and is applied and visually previewed to a user in real time or near-real time. In some such example implementations, the user can also modify and/or tune the convergence at every seam position and select the final position which gives the desired appearance (which may, for example be based on the least visually apparent image distortion).

In an example situation, an overlap area associated with a given panoramic image and/or other composite image may range from 20° to 60° depending on the amount of overlap between cameras, and a seam region (which may range from 5 to 20, based on the orientation and configuration of the cameras) is selected based on the identification of a region with a minimum error criterion to perform blending. In some situations involving 3D panoramas, there will typically be left and right views for every seam region. In cases involving 3D panoramas generated in connection with an OZO camera and/or a similar camera array or configuration, the left seam region is formed from an overlap of images captured by cameras C1 and C2 (which may be similar to those presented in FIG. 1, for example) and the right seam region is formed from an overlap of cameras C2 and C3, where camera C3 is positioned and/or arranged such that it has an overlapping portion with C2 that meets the relevant criteria for capturing a 3D image.

When performing a search for the optimum seam location and/or another seam location to be used in connection with the composite image, a convergence map (which, as described herein is computed on per-seam segment basis and is based at least in part on the depth associated with the elements in a given segment) is applied for a given seam region under evaluation. In one example implementation the resulting image regions are blended using a fast blending approach. In implementations involving a user interface, the output stitched region at the seam can be shown as a preview in real time or near-real time. As noted herein, the seam region could be horizontal, vertical, or conform to a different shape or profile, depending on the orientation of the cameras and the positioning of the overlapping images, for example. It will also be appreciated that the width of the seam region is variable and may not be constant for the entire seam region. In some example implementations, the seam width may be calculated and determined automatically from the depth map and/or another process applied to the overlapping region of the relevant images. For example, a mask may be used which adheres to the foreground object contours to provide a different seam width than that used with other portions of the seam region.

It will also be appreciated that in example implementations involving a user interface that allows a user to interact with the underlying images and to adjust the seam location, a manual curve editor may be used to tune the convergence value at one or more grid position in the seam region (including but not limited to at a every grid position in the seam region). The use of such a curve editor may be advantageous in situations where the automatic application of a depth-based convergence value provides undesirable results (such as errors due to an incorrect assessment of the relevant depth, disparity, and/or other value within a given image segment, for example.

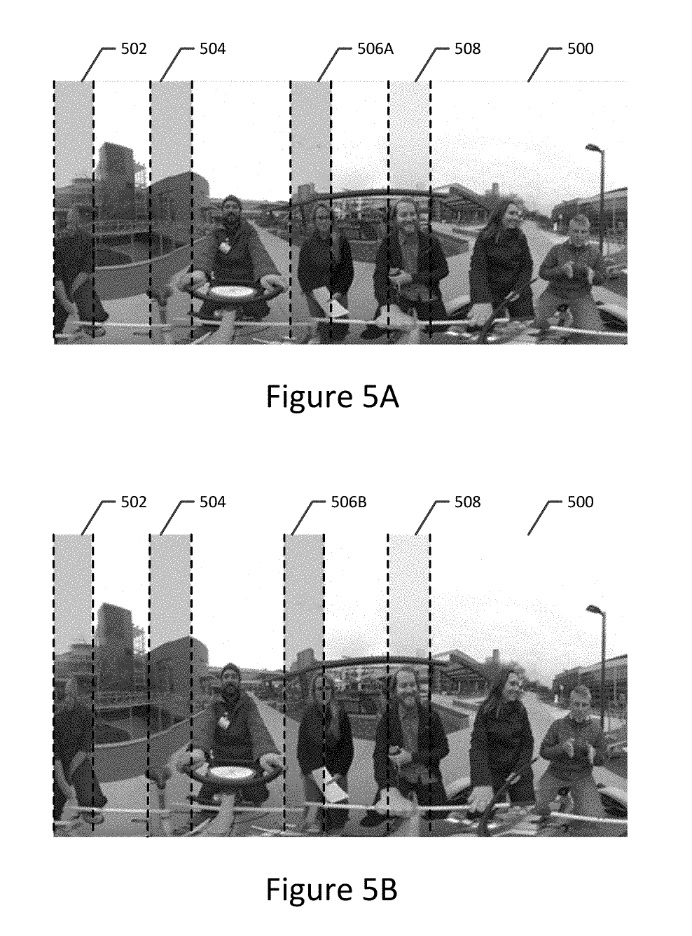

FIGS. 5A and 5B provide annotated versions of an image 500, wherein seam region are marked in dashed lines. As shown in FIG. 5A, seam regions 502, 504, 506a, and 508 are shown at various locations within the composite image 500 and may be associated, for example, with the overlapping regions of multiple cameras. As shown, the marked and shaded seam regions 502, 504, 506A, and 508 are arranged in a vertical orientation. However, it will be appreciated that in other example implementations, the seam regions may be horizontal (such as when stitching content from a top camera of the OZO system and/or a similar camera array to content from one or more of the cameras in a middle ring of camera, for example). Moreover, the seam regions may conform to other shapes and/or orientations, depending on the particulars of the camera array used to capture the relevant image content.

As shown in FIG. 5B, composite image 500 is provided with the seam regions 502, 504, and 508 in the same locations as shown in FIG. 5B. However, based on the application of the seam location approaches described herein, seam region 506B has been shifted to the left as compared to seam region 506A. In the example depicted in FIG. 5B, a depth-based convergence factor can be applied in real time and/or near-real time to the image and the corrected and/or otherwise adjusted image can be presented via a user interface to a viewer.

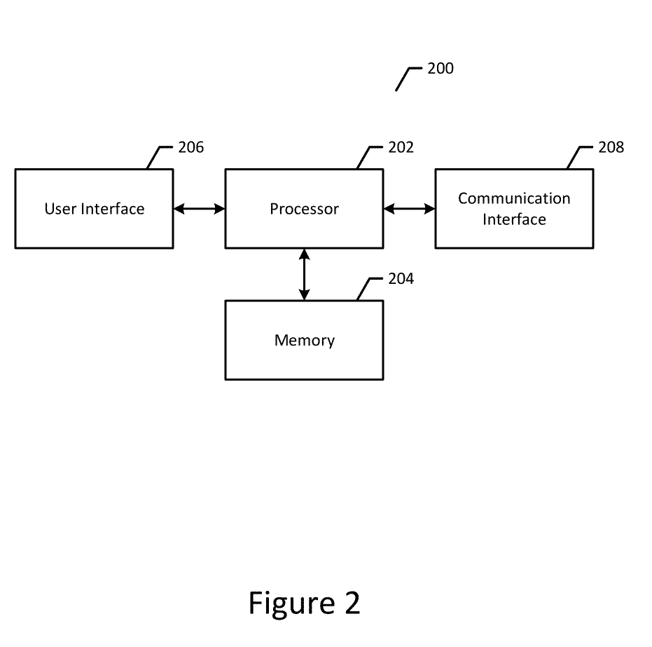

As discussed throughout herein, example embodiments of the invention disclosed and otherwise contemplated herein are directed toward providing improved panoramic and other composite images that may be formed by combining multiple images. Based upon the images captured by the cameras 101a and 101b, for example, a panoramic view is generated and combined in accordance with the techniques, approaches, and other developments described herein. In this regard, the panoramic view and/or other composite image may be generated by an apparatus 200 as depicted in FIG. 2. The apparatus may be embodied by one of the cameras or may be distributed between the cameras. Alternatively, the apparatus 200 may be embodied by another computing device, external from the cameras. For example, the apparatus may be embodied by a personal computer, a computer workstation, a server or the like, or by any of various mobile computing devices, such as a mobile terminal, e.g., a smartphone, a tablet computer, a video game player, etc. Alternatively, the apparatus may be embodied by a virtual reality system, such as a head mounted display.

Regardless of the manner in which the apparatus 200 is embodied, the apparatus of an example embodiment is configured to include or otherwise be in communication with a processor 202 and a memory device 204 and optionally the user interface 206 and/or a communication interface 208. In some embodiments, the processor (and/or co-processors or any other processing circuitry assisting or otherwise associated with the processor) may be in communication with the memory device via a bus for passing information among components of the apparatus. The memory device may be non-transitory and may include, for example, one or more volatile and/or non-volatile memories. In other words, for example, the memory device may be an electronic storage device (e.g., a computer readable storage medium) comprising gates configured to store data (e.g., bits) that may be retrievable by a machine (e.g., a computing device like the processor). The memory device may be configured to store information, data, content, applications, instructions, or the like for enabling the apparatus to carry out various functions in accordance with an example embodiment of the present invention. For example, the memory device could be configured to buffer input data for processing by the processor. Additionally or alternatively, the memory device could be configured to store instructions for execution by the processor.

As described above, the apparatus 200 may be embodied by a computing device. However, in some embodiments, the apparatus may be embodied as a chip or chip set. In other words, the apparatus may comprise one or more physical packages (e.g., chips) including materials, components and/or wires on a structural assembly (e.g., a baseboard). The structural assembly may provide physical strength, conservation of size, and/or limitation of electrical interaction for component circuitry included thereon. The apparatus may therefore, in some cases, be configured to implement an embodiment of the present invention on a single chip or as a single “system on a chip.” As such, in some cases, a chip or chipset may constitute means for performing one or more operations for providing the functionalities described herein.

The processor 202 may be embodied in a number of different ways. For example, the processor may be embodied as one or more of various hardware processing means such as a coprocessor, a microprocessor, a controller, a digital signal processor (DSP), a processing element with or without an accompanying DSP, or various other processing circuitry including integrated circuits such as, for example, an ASIC (application specific integrated circuit), an FPGA (field programmable gate array), a microcontroller unit (MCU), a hardware accelerator, a special-purpose computer chip, or the like. As such, in some embodiments, the processor may include one or more processing cores configured to perform independently. A multi-core processor may enable multiprocessing within a single physical package. Additionally or alternatively, the processor may include one or more processors configured in tandem via the bus to enable independent execution of instructions, pipelining and/or multithreading.

In an example embodiment, the processor 202 may be configured to execute instructions stored in the memory device 204 or otherwise accessible to the processor. Alternatively or additionally, the processor may be configured to execute hard coded functionality. As such, whether configured by hardware or software methods, or by a combination thereof, the processor may represent an entity (e.g., physically embodied in circuitry) capable of performing operations according to an embodiment of the present invention while configured accordingly. Thus, for example, when the processor is embodied as an ASIC, FPGA or the like, the processor may be specifically configured hardware for conducting the operations described herein. Alternatively, as another example, when the processor is embodied as an executor of software instructions, the instructions may specifically configure the processor to perform the algorithms and/or operations described herein when the instructions are executed. However, in some cases, the processor may be a processor of a specific device (e.g., a pass-through display or a mobile terminal) configured to employ an embodiment of the present invention by further configuration of the processor by instructions for performing the algorithms and/or operations described herein. The processor may include, among other things, a clock, an arithmetic logic unit (ALU) and logic gates configured to support operation of the processor.

In some embodiments, the apparatus 200 may optionally include a user interface 206 that may, in turn, be in communication with the processor 202 to provide output to the user and, in some embodiments, to receive an indication of a user input. As such, the user interface may include a display and, in some embodiments, may also include a keyboard, a mouse, a joystick, a touch screen, touch areas, soft keys, a microphone, a speaker, or other input/output mechanisms. Alternatively or additionally, the processor may comprise user interface circuitry configured to control at least some functions of one or more user interface elements such as a display and, in some embodiments, a speaker, ringer, microphone and/or the like. The processor and/or user interface circuitry comprising the processor may be configured to control one or more functions of one or more user interface elements through computer program instructions (e.g., software and/or firmware) stored on a memory accessible to the processor (e.g., memory device 204, and/or the like).

The apparatus 200 may optionally also include the communication interface 208. The communication interface may be any means such as a device or circuitry embodied in either hardware or a combination of hardware and software that is configured to receive and/or transmit data from/to a network and/or any other device or module in communication with the apparatus. In this regard, the communication interface may include, for example, an antenna (or multiple antennas) and supporting hardware and/or software for enabling communications with a wireless communication network. Additionally or alternatively, the communication interface may include the circuitry for interacting with the antenna(s) to cause transmission of signals via the antenna(s) or to handle receipt of signals received via the antenna(s). In some environments, the communication interface may alternatively or also support wired communication. As such, for example, the communication interface may include a communication modem and/or other hardware/software for supporting communication via cable, digital subscriber line (DSL), universal serial bus (USB) or other mechanisms.

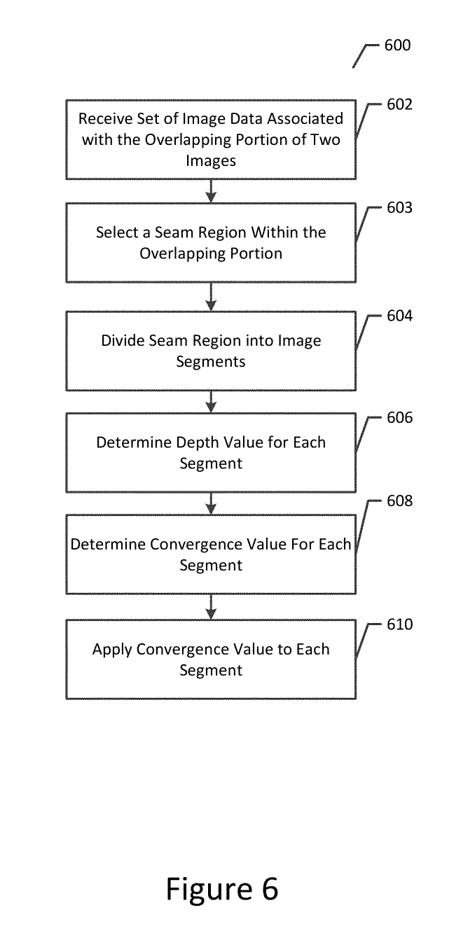

Referring now to FIG. 6, the operations performed by the apparatus 200 of FIG. 2 in accordance with an example embodiment of the present invention are depicted as a process flow 600. In this regard, the apparatus includes means, such as the processor 202, the memory 204, the user interface 206, the communication interface 208 or the like, for combining images captured by multiple cameras into a panoramic image, in a manner that reduces image defects and other artifacts at or near a seam between images.

As shown in FIG. 6, the apparatus includes means, such as the processor 202, the memory 204, the user interface 206, the communication interface 208 or the like, for receiving a set of image data associated with region of a first image and a set of image data associated with a region of a second image, wherein the region of the first image and the region of the second image comprise an overlapping portion of the first image and the second image. For example, and with reference to block 602 of FIG. 6, the apparatus 200 of an example embodiment may receive a set of image data associated with the overlapping portion of two images. As discussed herein, example implementations of embodiments of the invention often arise in circumstances where multiple cameras, such as the cameras of an OZO system and/or other implementations of the camera array shown in FIG. 1, for example, are used to capture images that may be stitched together to form a panoramic view. Any approach to receiving sets of image data may be used in connection with example implementations of block 602. In some example implementations of block 602, the images captured by the multiple cameras have at least some overlapping portions. Moreover, in some example implementations, the first image and the second image are components of a three-dimensional video image. In some such example implementations, and in other example implementations, it may be computationally efficient to pass portions of the captured images that do not overlap with other images directly to an output image, while the image data associated with the overlapping portions of the images may be processed in accordance with the processes, approaches, and/or other techniques disclosed and otherwise contemplated herein to blend the seam area of the overlapping images in a manner that features few, if any, visible artifacts or other defects.

The apparatus also includes means, such as the processor 202, the memory 204, the user interface 206, the communication interface 208 or the like, for selecting a seam location within the overlapping portion of the first image and the second image. For example, and with reference to block 603 of FIG. 6, the apparatus 200 of an example embodiment may select a seam location within the overlapping portion of the images. Any approach to selecting a seam location may be used in connection with example implementations of block 603. In some example implementations of block 603, selecting a seam location within the overlapping portion of the first image and the second image comprises automatically calculating an error metric associated with a seam region. In some such example implementations, the error metric is a distortion metric. However, it will be appreciated that other metrics may be used, including but not limited to other metrics and/or criteria associated with the appearance of a combined composite image.

The apparatus also includes means, such as the processor 202, the memory 204, the user interface 206, the communication interface 208 or the like, for dividing the overlapping portion of the first image and the second image into a plurality of seam regions, wherein each seam region in the plurality of seam regions is further divided into a plurality of image segments. For example, and with reference to block 604 of FIG. 6, the apparatus 200 of an example embodiment may divide the seam region into image segments. As described herein, example implementations of embodiments of the invention contemplate the division of the overlapping portion of two adjacent images into seam regions that can themselves be subdivided into segments along the length of the seam. As noted herein, dividing the seam region length into segments allows for each segment to be potentially evaluated (such as evaluated to determine depth, disparities, optical flows, and other aspects or metrics, for example) and processed individually in a computationally efficient manner. Any approach to dividing a seam region into segments may be used, and it will be appreciated that any of the segment characteristics and or seam region characteristics described and/or otherwise contemplated herein may be used in connection with example implementations of block 604. For example, it will be appreciated that in some example implementations, a seam width associated with seam region is variable along the length of the seam region.

The apparatus also includes means, such as the processor 202, the memory 204, the user interface 206, the communication interface 208 or the like, for determining, for each image segment, a depth value. For example, and with reference to block 606 of FIG. 6, the apparatus 200 of an example embodiment may determine a depth value for each segment. As described and otherwise contemplated herein, example implementations of embodiments of the invention contemplate the use of multiple segments, each of which can be adjusted with a segment-specific convergence value and/or other scaling factor to improve the appearance of the image stitching at the seam location. In some example implementations, an average depth level for each segment is determined through an analysis (such as may be performed by the apparatus 200 and/or passed to the apparatus 200 by one or more cameras and/or related equipment, for examples) of each segment. In some example implementations, a disparity may also be generated in the course of analyzing the depth of a given segment and/or as a separate analysis operation of a given segment. Any of the approaches described, disclosed, and/or otherwise contemplated herein may be used in connection with determining a depth value associated with a segment and in any other aspect of implementations of block 606.

The apparatus also includes means, such as the processor 202, the memory 204, the user interface 206, the communication interface 208 or the like, for determining, for each image segment, a convergence value, wherein the convergence value is based at least in part on the depth value of the image segment. For example, and with reference to block 608 of FIG. 6, the apparatus 200 of an example embodiment may determine a convergence value for each segment in a given seam region. Any approach to calculating a convergence value may be use used in connection with example implementations of block 608. For example, in some example implementations, a disparity map is translated into a convergence map through the application of a transfer function, such as the function or other transformation operation. In some example implementations, the average depth of a given segment is used in connection with the determination of the convergence value and/or other scaling factor to allow for elements at different depths to be scaled differently.

The apparatus also includes means, such as the processor 202, the memory 204, the user interface 206, the communication interface 208 or the like, for applying each convergence value to the image segment. For example, and with reference to block 610 of FIG. 6, the apparatus 200 of an example embodiment may apply the relevant convergence value to each corresponding segment. As discussed herein, one of the aims of example embodiments of the invention disclosed and otherwise contemplated herein is to allow elements at different depths along a seam to be scaled and/or otherwise converged in a depth-related manner on a per-segment basis. By applying the segment-specific convergence values to each segment, the pixels within a given segment can be adjusted to allow for stitching of images together in a manner that reduces artifacts and/or other defects in a segment-specific, depth related manner. Any approach to applying a convergence value to a segment or other set of pixels may be used in connection with example implementations of block 610.

In some example implementations of process 600, the process may further involve receiving an indication of a request by a user to relocate the seam location. As discussed herein, some example implementations contemplate an apparatus 200 or another related device that is capable of displaying an image and information regarding a seam location to a user, and receiving, such as via a user interface, for example, instructions from the user to move the seam location. In some such example implementations, upon receiving an indication to move the seam, the apparatus 200 may cause the seam location to be moved. In some situations, it may be advantageous to move the seam in real time near-real time and to redetermine and apply the relevant convergence factors such that a user may be able to visually verify the movement of the seam location and assess whether the relocation achieved the desired effect.

As described above, FIG. 6 illustrates a flowchart of an apparatus 200, method, and computer program product according to example embodiments of the invention. It will be understood that each block of the flowchart, and combinations of blocks in the flowchart, may be implemented by various means, such as hardware, firmware, processor, circuitry, and/or other devices associated with execution of software including one or more computer program instructions. For example, one or more of the procedures described above may be embodied by computer program instructions. In this regard, the computer program instructions which embody the procedures described above may be stored by the memory device 204 of an apparatus employing an embodiment of the present invention and executed by the processor 202 of the apparatus. As will be appreciated, any such computer program instructions may be loaded onto a computer or other programmable apparatus (e.g., hardware) to produce a machine, such that the resulting computer or other programmable apparatus implements the functions specified in the flowchart blocks. These computer program instructions may also be stored in a computer-readable memory that may direct a computer or other programmable apparatus to function in a particular manner, such that the instructions stored in the computer-readable memory produce an article of manufacture the execution of which implements the function specified in the flowchart blocks. The computer program instructions may also be loaded onto a computer or other programmable apparatus to cause a series of operations to be performed on the computer or other programmable apparatus to produce a computer-implemented process such that the instructions which execute on the computer or other programmable apparatus provide operations for implementing the functions specified in the flowchart blocks.

Accordingly, blocks of the flowchart support combinations of means for performing the specified functions and combinations of operations for performing the specified functions. It will also be understood that one or more blocks of the flowchart, and combinations of blocks in the flowchart, can be implemented by special purpose hardware-based computer systems which perform the specified functions, or combinations of special purpose hardware and computer instructions.

In some embodiments, certain ones of the operations above may be modified or further amplified. Furthermore, in some embodiments, additional optional operations may be included. Modifications, additions, or amplifications to the operations above may be performed in any order and in any combination.

Many modifications and other embodiments of the inventions set forth herein will come to mind to one skilled in the art to which these inventions pertain having the benefit of the teachings presented in the foregoing descriptions and the associated drawings. Therefore, it is to be understood that the inventions are not to be limited to the specific embodiments disclosed and that modifications and other embodiments are intended to be included within the scope of the appended claims. Moreover, although the foregoing descriptions and the associated drawings describe example embodiments in the context of certain example combinations of elements and/or functions, it should be appreciated that different combinations of elements and/or functions may be provided by alternative embodiments without departing from the scope of the appended claims. In this regard, for example, different combinations of elements and/or functions than those explicitly described above are also contemplated as may be set forth in some of the appended claims. Although specific terms are employed herein, they are used in a generic and descriptive sense only and not for purposes of limitation.

That which is claimed:

1. A method comprising:
receiving a set of image data associated with region of a first image and a set of image data associated with a region of a second image, wherein the region of the first image and the region of the second image comprise an overlapping portion of the first image and the second image;
selecting a seam region with in the overlapping portion of the first image and the second image;
dividing the seam region into a plurality of image segments;
determining, for each image segment, a depth value;
determining, for each image segment, a convergence value, wherein the convergence value is based at least in part on the depth value of the image segment; and
applying each convergence value to the image segment.

2. A method according to claim 1, wherein the first image and the second image are components of a three-dimensional video image.

3. A method according to claim 1, wherein a seam width associated with seam region is variable along the length of the seam region.

4. A method according to claim 1, wherein the convergence value is further based on a disparity map associated with the overlapping portion of the first image and the second image.

5. A method according to claim 1, wherein selecting a seam location within the overlapping portion of the first image and the second image comprises automatically calculating an error metric associated with a seam region.

6. A method according to claim 5, wherein the error metric is an image distortion error metric.

7. A method according to claim 1, the method further comprising:
receiving an indication of a request by a user to relocate the seam location; and
relocating the seam location.

8. An apparatus comprising at least one processor and at least one memory storing computer program code, the at least one memory and the computer program code configured to, with the processor, cause the apparatus to at least:
receive a set of image data associated with region of a first image and a set of image data associated with a region of a second image, wherein the region of the first image and the region of the second image comprise an overlapping portion of the first image and the second image;
select a seam region with in the overlapping portion of the first image and the second image;
divide the seam region into a plurality of image segments;
determine, for each image segment, a depth value;
determine, for each image segment, a convergence value, wherein the convergence value is based at least in part on the depth value of the image segment; and
apply each convergence value to the image segment.

9. An apparatus according to claim 8, wherein the first image and the second image are components of a three-dimensional video image.

10. An apparatus according to claim 8, wherein a seam width associated with seam region is variable along the length of the seam region.

11. An apparatus according to claim 8, wherein the convergence value is further based on a disparity map associated with the overlapping portion of the first image and the second image.

12. An apparatus according to claim 8, wherein selecting a seam location within the overlapping portion of the first image and the second image comprises automatically calculating an error metric associated with a seam region.

13. An apparatus according to claim 12, wherein the error metric is an image distortion error metric.

14. An apparatus according to claim 8, the at least one memory and the computer program code further configured to, with the processor, cause the apparatus to at least:
receive an indication of a request by a user to relocate the seam location; and
relocate the seam location.

15. A computer program product comprising at least one non-transitory computer-readable storage medium having computer-executable program code instruction stored therein, the computer-executable program code instructions comprising program code instructions configured to:
receive a set of image data associated with region of a first image and a set of image data associated with a region of a second image, wherein the region of the first image and the region of the second image comprise an overlapping portion of the first image and the second image;
select a seam region with in the overlapping portion of the first image and the second image;
divide the seam region into a plurality of image segments;
determine, for each image segment, a depth value;
determine, for each image segment, a convergence value, wherein the convergence value is based at least in part on the depth value of the image segment; and
apply each convergence value to the image segment.

16. A computer program product according to claim 15, wherein the first image and the second image are components of a three-dimensional video image.

17. A computer program product according to claim 15, wherein a seam width associated with seam region is variable along the length of the seam region.

18. A computer program product according to claim 15, wherein the convergence value is further based on a disparity map associated with the overlapping portion of the first image and the second image.

19. A computer program product according to claim 15, wherein selecting a seam location within the overlapping portion of the first image and the second image comprises automatically calculating an error metric associated with a seam region.

20. A computer program product according to claim 15, the computer-executable program code instructions further comprising program code instructions configured to:
receive an indication of a request by a user to relocate the seam location; and
relocate the seam location.
